(19) United States
(12) Patent Application Publication
(10) Pub. No.: US 2013/0045853 A1
(43) Pub. Date: Feb. 21, 2013

(54) METHOD OF PRODUCING POROUS GLASS

(71) Applicants: Yoshinori Kotani, Yokohama-shi (JP); Zuyi Zhang, Yokohama-shi (JP); Kenji Takashima, Tokyo (JP)

(72) Inventors: Yoshinori Kotani, Yokohama-shi (JP); Zuyi Zhang, Yokohama-shi (JP); Kenji Takashima, Tokyo (JP)

(73) Assignee: CANON KABUSHIKI KAISHA, Tokyo (JP)

(21) Appl. No.: 13/643,667

(22) PCT Filed: May 13, 2011
(86) PCT No.: PCT/JP2011/061606

§ 371 Date: Oct. 26, 2012

(30) Foreign Application Priority Data
May 20, 2010 (JP) 2010-116763

(51) Int. Cl. C03C 11/00

(52) U.S. Cl. 501/39

(57) ABSTRACT

Provided is a method of producing a porous glass having a high strength by a safe, simple process that does not involve the use of any high-temperature heat treatment or acid treatment step. The method includes: mixing 4 wt % or more to 6.5 wt % or less of sodium oxide, 26 wt % or more to 36 wt % or less of boron oxide, and 60 wt % or more to 68 wt % or less of silicon oxide; heating the mixed materials to melt the materials and cooling the molten materials to obtain a glass body; and a step involving bringing the glass body into contact with water without reheating the glass body to obtain the porous glass.

### TECHNICAL FIELD

The present invention relates to a method of producing a phase-separated glass and a porous glass.

### BACKGROUND ART

Porous glasses produced by utilizing the phase separation phenomenon of glass each have a unique porous structure that is uniformly controlled, and the pore diameters of the structure can each be changed within a certain range. The porous glasses are expected to find use in industrial applications such as adsorbents, microcarriers, separation membranes, and optical materials by taking advantage of such excellent features.

A phase-separated region that has been conventionally known has such a composition that sodium oxide accounts for about 7 to 10 wt %, boron oxide accounts for about 22 to 59 wt %, and silicon oxide accounts for about 30 to 80 wt %. The porous glasses are each generally obtained by: treating a glass body with heat at 500 to 700° C. to cause a phase separation; and etching the treated product with an acid to make the product porous (see, for example, NPL 1).

PTL 1 proposes a method of obtaining a porous glass with a phase-separated glass obtained by adding Al₂O₃ and ZrO₂ to an Na₂O—B₂O₃—SiO₂ glass for the purpose of improving chemical durability such as water durability and alkali durability. In the method, the porous glass is produced by employing a conventional method involving the use of a heat treatment for a phase separation and an acid treatment.

Accordingly, the production of a porous glass by means of the phase separation phenomenon requires (1) a heat treatment for a phase separation and (2) an acid treatment for removing an eluted phase. However, (1) the phase separation treatment requires a high-temperature, long-term heat treatment. In addition, an acid must be used in (2) the acid treatment, and attention should be paid to its handling. A water-washing treatment after the acid treatment is also needed, and hence the production of the porous glass by means of the phase separation phenomenon involves a large number of treatment steps. In the prior art, no examples in which porous glasses are produced without the performance of any heat treatment for a phase separation or any acid treatment step have been reported.

As described above, in the production of a porous glass by means of the phase separation phenomenon, a phase separation treatment requires a high-temperature, long-term heat treatment. In addition, an acid must be used in an acid treatment, and attention should be paid to its handling. A water-washing treatment after the acid treatment is also needed, and hence the production of the porous glass by means of the phase separation phenomenon involves a large number of handling steps.

Accordingly, there has been a demand for a porous glass which: can omit a high-temperature heat treatment and an acid treatment step where attention should be paid upon handling of needed stuff; and can be obtained by a safe, simple process.

The present invention has been made in view of such background art, and an object of the present invention is to provide the method of producing a porous glass having a high strength. The method is a safe, simple process that does not involve the use of any high-temperature heat treatment or acid treatment step in the production of the porous glass.

### CITATION LIST

### Patent Literature

PTL 1: Japanese Patent Application Laid-Open No. 2006-193341

### Non Patent Literature

NPL 1: “New Glass and Its Physical Properties,” chap. 2, p. 47 to 50, supervised by Tetsuro Izumiya, Management System Laboratory. Co., Ltd., published in 1987

### SUMMARY OF INVENTION

In order to solve the above-mentioned problem, a method of producing a porous glass of the present invention includes: mixing 4 wt % or more to 6.5 wt % or less of sodium oxide, 26 wt % or more to 36 wt % or less of boron oxide, and 60 wt % or more to 68 wt % or less of silicon oxide; heating the mixed materials to melt the materials and cooling the molten materials to provide a glass body; and bringing the glass body into contact with water without reheating the glass body to provide the porous glass.

According to the present invention, a porous glass having a high strength can be obtained by a safe, simple process that does not involve the use of any high-temperature heat treatment or acid treatment step in the production of the porous glass.

Further features of the present invention will become apparent from the following description of exemplary embodiments with reference to the attached drawings.

### BRIEF DESCRIPTION OF DRAWINGS

FIG. 1 is a view obtained by observing the glass surface of a plate-like glass in Example 1 of the present invention after a water-washing treatment with an electron microscope.

FIG. 2 is a view obtained by observing the glass surface of a plate-like glass in Comparative Example 1 after a water-washing treatment with an electron microscope.

FIG. 3 is a view illustrating the Na₂O—B₂O₃—SiO₂ glass compositions of Examples and Comparative Examples.

### DESCRIPTION OF EMBODIMENTS

Hereinafter, a general method of producing a porous glass involving the utilization of the phase separation phenomenon of glass is described prior to detailed description of the present invention.

Examples of the material of the phase-separated glass body include silicon oxide-based glass body such as silicon oxide-boron oxide-alkali metal oxide and silicon oxide-phosphate-alkali metal oxide. Of those, borosilicate glass as silicon oxide-boron oxide-alkali metal oxide is preferably used for the phase-separated glass body.

A method of producing the phase-separated glass body is as described below. The phase-separated glass body can be produced by: preparing raw materials so that the above-mentioned composition may be achieved; heating the raw materials containing the supply sources of the respective components to melt the raw materials; and molding the molten raw materials into a desired shape as required. A melt heating temperature for heating the raw materials to melt the raw materials, which has only to be appropriately set depending on, for example, the composition of the raw materials, typically falls within the range of preferably 1350 to 1450° C. and particularly preferably 1380 to 1430° C. In the specification, heating for melting the raw materials is referred to as “melt heating.”

For example, the following case is permitted. Sodium carbonate, boric acid, and silicon dioxide are uniformly mixed as the above-mentioned raw materials, and then the mixture is heated to 1350 to 1450° C. so as to melt. In this case, all kinds of raw materials may be used as the raw materials as long as the raw materials contain the components, i.e., an alkali metal oxide, boron oxide, and silicon oxide as described above.

In addition, when the porous glass is formed into a predetermined shape, after the phase-separated glass body has been synthesized, the glass has only to be molded into any one of the various shapes such as a tubular shape, a plate-like shape, and a spherical shape at a temperature of generally 1000 to 1200° C. For example, the following method can be suitably adopted. After the glass body has been synthesized by melting the above-mentioned raw materials, the glass is molded in a state where the temperature is lowered from a melting temperature and kept at 1000 to 1200° C.

In general, the phase-separated glass body is treated under heat so that the glass body may be phase-separated. For example, when a borosilicate glass of silicon oxide-boron oxide-alkali metal oxide is used as the glass body, the term “phase-separate” means that a phase separation of several nanometers in scale is caused between a silicon oxide-rich phase and an alkali metal oxide-boron oxide-rich phase in the glass. A phase separation heating temperature for a phase separation is set to 400 to 800° C., and a phase separation heating time can be appropriately set within the range of 20 to 100 hours depending on, for example, the fine pore diameters of the porous glass to be obtained in ordinary cases. In the specification, heating for phase-separating the glass body is referred to as “phase separation heating.”

The phase-separated glass obtained by the phase separation heating step as described above is brought into contact with an acid solution so that an acid-soluble component may be removed by elution. For example, an inorganic acid such as hydrochloric acid or nitric acid can be preferably used as the acid solution, and the acid solution can be suitably used in such a form that water is used as a solvent in ordinary cases. The concentration of the acid solution has only to be appropriately set within the range of 0.1 to 2 mol/L (0.1 to 2 N) in ordinary cases. In the acid treatment step of bringing the glass into contact with the acid solution, the temperature of the acid solution has only to be set to fall within the range of room temperature to 100° C., and a treatment time has only to be set to about 1 to 50 hours. After that, the treated product is subjected to a washing treatment with water. As a result, a porous glass having a skeleton based on silicon oxide is obtained. The temperature of water in the step of the washing treatment with water has only to be set to fall within the range of room temperature to 100° C. in general. A time for the step of the washing treatment with water, which can be appropriately determined depending on, for example, the composition and size of the glass of interest, has only to be set to about 1 to 50 hours in ordinary cases.

A method of producing a porous glass according to the present invention is characterized by including: mixing 4 wt % or more to 6.5 wt % or less of sodium oxide, 26 wt % or more to 36 wt % or less of boron oxide, and 60 wt % or more to 68 wt % or less of silicon oxide; heating the mixed materials to melt the materials and cooling the molten materials to obtain a glass body; and bringing the glass body into contact with water without reheating the glass body to obtain the porous glass.

The porous glass can be obtained by performing a water-washing treatment involving bringing the above-mentioned glass body into contact with water.

Characteristic of the present invention is as described below. The glass body is specified within the composition range, the porous glass can be obtained only by subjecting the glass body to the water-washing treatment without through any phase separation heat treatment or acid treatment.

With regard to preferred compositions of the mixed materials and the glass body used in the present invention, the content of sodium oxide is preferably 4 wt % or more to 6.5 wt % or less, and particularly preferably 4.5 wt % or more to 6 wt % or less in ordinary cases.

The content of boron oxide is preferably 26 wt % or more to 36 wt % or less, and particularly preferably 26.5 wt % or more to 35.5 wt % or less in ordinary cases.

The content of silicon oxide is preferably 60 wt % or more to 68 wt % or less, and particularly preferably 60.5 wt % or more to 67.5 wt % or less in ordinary cases.

Adopting the above-mentioned composition obviates the need for a phase separation heat treatment or acid treatment, and hence the porous glass can be obtained by the water-washing treatment alone. There is no need to reheat the glass body in the composition region of the present invention because the glass body has already undergone a phase separation. In addition, a good, high-strength porous structure can be obtained by the water-washing treatment of bringing the glass body into contact with water alone without the performance of any acid treatment of bringing the glass body into contact with an acid solution. In the case where an acid treatment is performed, the strength may reduce as compared with that in the case where the porous structure is produced by the water-washing treatment alone because a silica skeleton dissolves to an unnecessary extent. The water-washing treatment is typically performed by immersing the glass body in an aqueous solution having a temperature of 50° C. or more to 100° C. or less prepared with water in a neutral region. A time for the water-washing treatment has only to be set to about 1 to 50 hours.

Another characteristic of the present invention is as described below. The total content of sodium oxide, boron oxide, and silicon oxide in the sodium oxide-boron oxide-silicon oxide-based glass body is 99 wt % or more to 100 wt % or less with respect to the entirety of the phase-separated glass. The glass body may contain an oxide having more than three components in addition to the above-mentioned three-component-based oxide. Examples of the silicon oxide-based glass body include silicon oxide-boron oxide-alkali metal oxide-(alkaline earth metal oxide, zinc oxide, aluminum oxide, or zirconium oxide), titanium oxide-based glass body (silicon oxide-boron oxide-calcium oxide-magnesium oxide-aluminum oxide-titanium oxide), and rare earth-based glass body (boron oxide-alkali metal oxide-(cerium oxide, thorium oxide, hafnium oxide, or lanthanum oxide)). A fourth component of an oxide having more than three components is exemplified by aluminum oxide, zirconium oxide, or an alkaline earth metal oxide, but is not limited thereto. The content of the fourth component is less than 1 wt %. When the content is 1 wt % or more, the phase separation rate of the glass body is affected. As a result, it is difficult to obtain the porous glass through water-washing treatment alone in the present invention.

A porous glass similar to that produced by the general production method can be obtained from the sodium oxide-boron oxide-silicon oxide-based phase-separated glass within the above-mentioned composition range even by the water-washing treatment alone without the performance of any heat treatment or acid treatment.

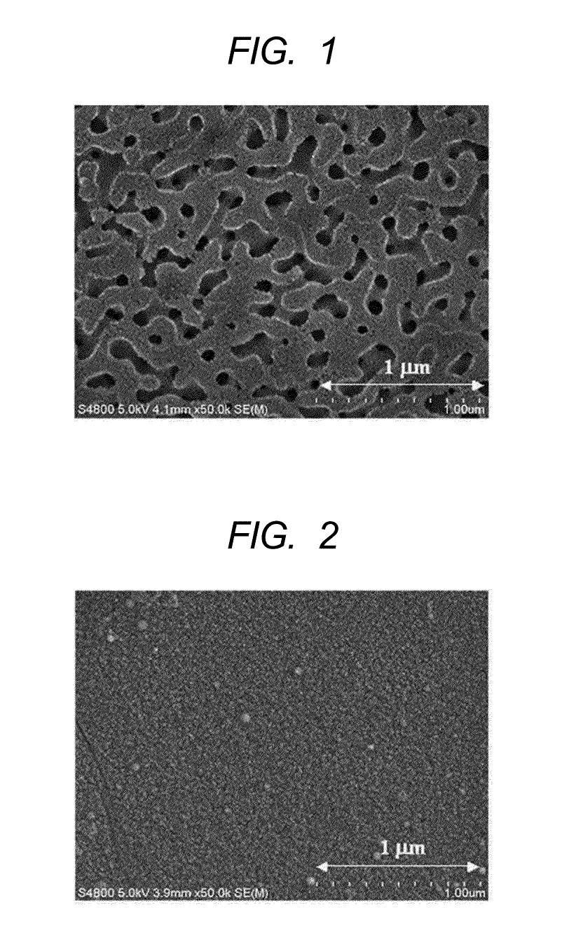

A porous glass of the present invention is characterized in that the porous glass has a spinodal structure based on silicon oxide. The phase separations are classified into a spinodal type and a binodal type. With regard to the fine pores of a porous glass obtained by a spinodal-type phase separation, fine through holes linked from the surface to the inside are formed as illustrated in FIG. 1. The structure in which the skeleton of a silicon oxide main component is continuously formed as illustrated in FIG. 1 is referred to as “spinodal structure based on silicon oxide” in the specification. The fine through holes linked from the surface to the inside are formed by the spinodal structure based on silicon oxide. A binodal-type phase separation provides a structure having closed pores. It has been well known that fine pore diameters and their distribution can be controlled depending on conditions for the heat treatment during the production of the porous glass. Of the phase separation phenomena, the spinodal-type phase separation that provides a porous structure having fine through holes linked from the surface to the inside, i.e., the so-called spinodal structure is preferred.

The average fine pore diameter of the porous glass, which is not particularly limited, desirably falls within the range of 1 nm to 1 μm, particularly 2 nm to 0.5 μm, and further particularly 10 nm to 0.1 μm.

The average fine pore diameter in the present invention is defined as follows. Pore of the porous glass surface is approximated with plural ellipses and then average of the short diameters of the approximated ellipses are determined. The determined average diameter is the average fine pore diameter. Specifically, pores are approximated with plural ellipses using an electron microgrph of the porous glass surface. Average of short diameters of the ellipses is determined. At least thirty points are measured and the average are determined.

The porous glass desirably has a porosity of 10 to 90% and particularly 20 to 80% in ordinary cases.

The porosity in the present invention is defined as a ratio of pore when an area of the porous glass surface is 1. Specifically, skeleton portion and pore portion are binarized using an electron microgrph of the porous glass surface and then porosity is determined by the ratio.

The shape of the porous glass is not particularly limited, and the porous glass is, for example, a membrane-like molded body of a tubular or plate-like shape. Those shapes can be appropriately selected depending on, for example, the applications of the porous glass.

The porous glass is expected to find use in applications such as adsorbents, microcarriers, separation membranes, and optical materials because its porous structure can be uniformly controlled and its pore diameters can each be changed within a certain range.

Hereinafter, the present invention is described specifically by way of examples, but the present invention is not limited to such examples.

The porous glasses of the respective examples and comparative examples were evaluated by the following method.

### Surface Observation

The surface of a porous glass was observed with a scanning electron microscope (FE-SEMS-4800, manufactured by Hitachi, Ltd.) (accelerating voltage; 5 kV, magnification; 50,000).

### Example 1

Sodium carbonate, boric acid, and silicon dioxide were used as glass raw materials. Those raw materials were uniformly mixed at a composition ratio “Na₂O:B₂O₃:SiO₂” of 5:30:65 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “5Na₂O.30B₂O₃.65SiO₂ (wt %)” obtained by cutting the above-mentioned plate-like glass into a square about one centimeter on a side was immersed in an ion-exchanged water warmed to 80° C. for 3 hours. Thus, a porous glass was obtained. FIG. 1 illustrates the result of the observation of the glass surface of the resultant porous glass with an electron microscope. As can be seen from FIG. 1, a spinodal-type porous structure is formed. In addition, the resultant porous glass showed no cracking in association with water absorption.

### Example 2

Sodium carbonate, boric acid, and silicon dioxide were used as glass raw materials. Those raw materials were uniformly mixed at a composition ratio “Na₂O:B₂O₃:SiO₂” of 4.5:34:61.5 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “4.5Na₂O.34B₂O₃.61.5SiO₂ (wt %)” obtained by cutting the above-mentioned plate-like glass into a square about one centimeter on a side was immersed in an ion-exchanged water warmed to 80° C. for 3 hours. Thus, a porous glass was obtained. The surface of a glass thus obtained was observed with an electron microscope. As a result, a spinodal-type porous structure was found to be formed as in the case of Example 1. In addition, the resultant porous glass showed no cracking in association with water absorption.

### Example 3

Sodium carbonate, boric acid, and silicon dioxide were used as glass raw materials. Those raw materials were uniformly mixed at a composition ratio “Na₂O:B₂O₃:SiO₂” of 6:27:67 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “6Na₂O.27B₂O₃.67SiO₂ (wt %)” obtained by cutting the above-mentioned plate-like glass into a square about one centimeter on a side was immersed in an ion-exchanged water warmed to 80° C. for 3 hours. Thus, a porous glass was obtained. The surface of a glass thus obtained was observed with an electron microscope. As a result, a spinodal-type porous structure was found to be formed as in the case of Example 1. In addition, the resultant porous glass showed no cracking in association with water absorption.

### Comparative Example 1

Sodium carbonate, boric acid, and silicon dioxide were used as glass raw materials. Those raw materials were uniformly mixed at a composition ratio “Na₂O:B₂O₃:SiO₂” of 14:21:65 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “14Na₂O.21B₂O₃.65SiO₂ (wt %)” obtained by cutting the above-mentioned plate-like glass into a square about one centimeter on a side was immersed in an ion-exchanged water warmed to 80° C. for 3 hours. FIG. 2 illustrates the result of the observation of the surface of a glass thus obtained with an electron microscope. As can be seen from FIG. 2, the surface seems to be somewhat rough but does not seem to be made porous, and hence no spinodal-type porous structure is formed.

### Comparative Example 2

Sodium carbonate, boric acid, and silicon dioxide were used as glass raw materials. Those raw materials were uniformly mixed at a composition ratio “Na₂O:B₂O₃:SiO₂” of 11:24:65 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “11Na₂O.24B₂O₃.65SiO₂ (wt %)” obtained by cutting the above-mentioned plate-like glass into a square about one centimeter on a side was immersed in an ion-exchanged water warmed to 80° C. for 3 hours. The surface of a glass thus obtained was observed with an electron microscope. As a result, the surface did not seem to be made porous as in the case of Comparative Example 1, and hence no spinodal-type porous structure was formed.

### Comparative Example 3

Sodium carbonate, boric acid, silicon dioxide, and alumina were used as glass raw materials. Those raw materials were uniformly mixed at a composition ratio “Na₂O:B₂O₃:SiO₂:Al₂O₃” of 8:14:76:2 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “8Na₂O.14B₂O₃.76SiO₂.2Al₂O₃ (wt %)” obtained by cutting the above-mentioned plate-like glass into a square about one centimeter on a side was immersed in an ion-exchanged water warmed to 80° C. for 3 hours. The surface of a glass thus obtained was observed with an electron microscope. As a result, the surface did not seem to be made porous as in the case of Comparative Example 1, and hence no spinodal-type porous structure was formed.

### Comparative Example 4

Sodium carbonate, boric acid, silicon dioxide, and alumina were used as glass raw materials. Those raw materials were uniformly mixed at a composition ratio “Na₂O:B₂O₃:SiO₂:Al₂O₃” of 14:14:70:2 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “14Na₂O.14B₂O₃.70SiO₂.2Al₂O₃ (wt %)” obtained by cutting the above-mentioned plate-like glass into a square about one centimeter on a side was immersed in an ion-exchanged water warmed to 80° C. for 3 hours. The surface of a glass thus obtained was observed with an electron microscope. As a result, the surface did not seem to be made porous as in the case of Comparative Example 1, and hence no spinodal-type porous structure was formed.

### Comparative Example 5

Sodium carbonate, boric acid, silicon dioxide, and alumina were used as glass raw materials. Those raw materials were uniformly mixed at a composition ratio “Na₂O:B₂O₃:SiO₂:Al₂O₃” of 9:30.5:59:1.5 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “9Na₂O.30.5B₂O₃.59SiO₂.1.5Al₂O₃ (wt %)” obtained by cutting the above-mentioned plate-like glass into a square about one centimeter on a side was immersed in an ion-exchanged water warmed to 80° C. for 3 hours. The surface of a glass thus obtained was observed with an electron microscope. As a result, the surface did not seem to be made porous as in the case of Comparative Example 1, and hence no spinodal-type porous structure was formed.

### Comparative Example 6

Sodium carbonate, boric acid, silicon dioxide, and alumina were used as glass raw materials. Those raw materials were uniformly mixed at a composition ratio “Na₂O:B₂O₃:SiO₂:Al₂O₃” of 4.5:19:75:1.5 (wt %), and then the mixture was heated at 1350 to 1450° C. so as to melt. After that, the resultant was naturally cooled in a state of being molded into a plate-like shape. Thus, a plate-like glass having a thickness of about 1 mm was obtained.

A glass body having a composition “4.5Na₂O.19B₂O₃.75SiO₂.1.5Al₂O₃ (wt %)” obtained by cutting the above-mentioned plate-like glass into a square about one centimeter on a side was immersed in an ion-exchanged water warmed to 80° C. for 3 hours. The surface of a glass thus obtained was observed with an electron microscope. As a result, the surface did not seem to be made porous as in the case of Comparative Example 1, and hence no spinodal-type porous structure was formed.

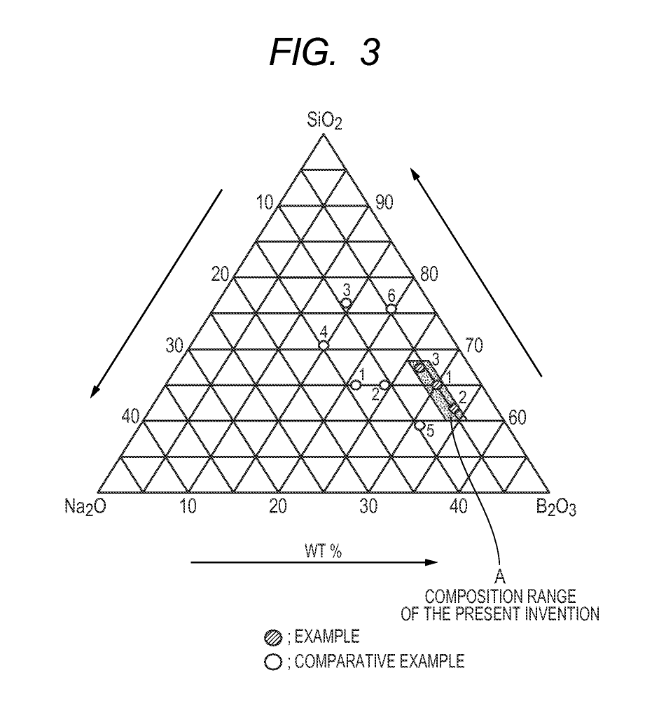

FIG. 3 illustrates the Na₂O—B₂O₃—SiO₂ glass compositions of the above-mentioned examples and comparative examples as a whole. In the figure, A represents the range of the glass composition of the present invention. It should be noted that symbols 1 to 3 provided for shaded circles represent Examples 1 to 3, and symbols 1 to 6 provided for open circles represent Comparative Examples 1 to 6.

### INDUSTRIAL APPLICABILITY

The phase-separated glasses of the present invention and the porous glasses obtained from the glasses are porous glasses obtained by a safe, simple process that does not require any particular heat treatment for a phase separation or any particular acid treatment step for etching. Accordingly, the porous glasses can be utilized as extremely useful materials in the fields of optics such as an optical member and a separating material, precision machines, electronics, and food engineering.

While the present invention has been described with reference to exemplary embodiments, it is to be understood that the invention is not limited to the disclosed exemplary embodiments.

This application claims the benefit of Japanese Patent Application No. 2010-116763, filed May 20, 2010, which is hereby incorporated by reference herein in its entirety.

1. A method of producing a porous glass, the method comprising:
mixing from 4 wt % to 6.5 wt % of sodium oxide, from 26 wt % to 36 wt % of boron oxide, and from 60 wt % to 68 wt % of silicon oxide, where a total content of sodium oxide, boron oxide, and silicon oxide to be mixed is from 99 wt % to 100 wt % of a total weight of materials to be mixed;
heating the mixed materials to melt the materials and cooling the molten materials to obtain a glass body; and
bringing the glass body into contact with water without reheating the glass body to obtain the porous glass.

2. The method of producing a porous glass according to claim 1, wherein a content of sodium oxide is from 4.5 wt % to 6 wt % or less.

3. (canceled)

4. The method of producing a porous glass according to claim 1, wherein the mixed materials are heated at a temperature from 1350° C. to 1450° C.

5. The method of producing a porous glass according to claim 1, wherein the water has a temperature from 50° C. to 100° C.

6. The method of producing a porous glass according to claim 2, wherein a content of boron oxide is from 26.5 wt % to 35.5 wt % and a content of silicon oxide is from 60.5 wt % to 67.5 wt %.

7. A method of producing a porous glass, the method comprising:
mixing from 4 wt % to 6.5 wt % of sodium oxide, from 26 wt % to 36 wt % of boron oxide, and from 60 wt % to 68 wt % of silicon oxide, where a total content of sodium oxide, boron oxide, and silicon oxide to be mixed is from 99 wt % to 100 wt % of a total weight of materials to be mixed;
heating the mixed materials to melt the materials and cooling the molten materials to obtain a glass body; and
bringing the glass body into contact with water without reheating the glass body and without an acid treatment to obtain the porous glass.

8. The method of producing a porous glass according to claim 7, wherein a content of sodium oxide is from 4.5 wt % to 6 wt %.

9. The method of producing a porous glass according to claim 7, wherein the mixed materials are heated at a temperature from 1350° C. to 1450° C.

10. The method of producing a porous glass according to claim 7, wherein the water has a temperature from 50° C. to 100° C.

11. The method of producing a porous glass according to claim 8, wherein a content of boron oxide is from 26.5 wt % to 35.5 wt % and a content of silicon oxide is from 60.5 wt % to 67.5 wt %.

12. A glass body comprising:
from 4 wt % to 6.5 wt % of sodium oxide;
from 26 wt % to 36 wt % of boron oxide; and
from 60 wt % to 68 wt % of silicon oxide,
wherein a total content of sodium oxide, boron oxide, and silicon oxide is from 99 wt % to 100 wt % of a total weight of materials in the glass body.
